(19) United States
(12) Patent Application Publication
(10) Pub. No.: US 2026/0317155 A1
(43) Pub. Date: Oct. 15, 2026

(54) Drive for a Container Pump and Container Pump Having Such a Drive

(71) Applicant: FLUX-GERÄTE GMBH, Maulbronn (DE)

(72) Inventor: Sebastian Morning, Bönningheim (DE)

(73) Assignee: FLUX-GERÄTE GMBH, Maulbronn (DE)

(21) Appl. No.: 19/641,745

(22) Filed: Apr. 8, 2026

(30) Foreign Application Priority Data
Apr. 9, 2025 (DE) 10 2025 001 255.1

(51) Int. Cl. B67D 7/08; B67D 7/62; F04D 3/00; F04D 13/06

(52) U.S. Cl. CPC B67D 7/08; B67D 7/62; F04D 3/00; F04D 13/06

(57) ABSTRACT

A drive for a container pump and a container pump including such a drive are disclosed. The drive is configured to drive a pump shaft of a pump tube assembly of the container pump. The drive includes a controller having a filling control configured to execute at least one filling program, wherein a quantity of a pumped medium is pumped in a time-controlled manner. The filling control enables sufficiently accurate and efficient filling for a wide range of applications.

### CROSS-REFERENCE TO RELATED APPLICATION

This application claims the benefit of German Patent Application DE 10 2025 001 255.1, filed on Apr. 9, 2025, the content of which is incorporated in its entirety.

### TECHNICAL FIELD

The present disclosure relates to a drive for a container pump and to a container pump including such a drive. A container pump is a pump system configured to transfer a liquid medium from a container, such as a drum, barrel, tank, or intermediate bulk container.

### BACKGROUND

In modern production technology, when filling or transferring liquids from a supply container into a target container, it is necessary that the filled quantities be as precise as possible. A container pump is inserted into the supply container filled with the medium to be pumped or connected to the discharge outlet of the container, by means of which the medium is conveyed via a hose line to the target container. At the end of the hose line there is a dispensing nozzle by means of which the flow of the medium through the hose line can be enabled or blocked. Since the dispensing nozzle is operated manually, it cannot be avoided that varying filling quantities are delivered into the target container.

### SUMMARY

It is an object to provide a drive and a container pump that enable sufficiently accurate and efficient filling of a pumped medium in a simple manner.

This object is achieved by a drive including a controller with a filling control configured to execute at least one filling program, wherein pumping is performed in a time-controlled manner.

The filling control of the drive ensures that a precise quantity of medium is always pumped out of the supply container. The filling control has at least one filling program, by which the medium is pumped out in a time-controlled manner. The time control ensures a precise quantity of medium. Depending on the time specified in the filling program, different delivery quantities are pumped out.

It is advantageous if, for the time control, not only the filling time but also the rotational speed of the drive is taken into account. In this way, the delivery quantity can be set very precisely.

Effective yet simple filling is possible when the filling control comprises a plurality of filling programs. These can be selected by the operator. This makes it very easy to take into account different media, different container pumps, and also different pump mechanisms when selecting the filling program.

An efficient mode of operation is advantageously achieved if the filling program is stored in a memory. The user can then easily call up the filling program stored in the memory. In particular, if several filling programs are stored in the memory, the user can easily retrieve the corresponding filling programs.

The memory is advantageously accommodated in the drive itself. It is also possible to provide the memory outside the drive, for example in a cloud. The user can then retrieve the filling program from the cloud. For this purpose, the drive is advantageously equipped with corresponding means for wireless communication.

It is particularly advantageous if the drive automatically switches off upon expiration of the set time. It is then reliably ensured that not too much medium is pumped out of the supply container.

An electric motor is advantageously used as the drive.

A particularly versatile application is ensured if the filling control can be parameterized for generating further filling programs. The operator can then program the filling program required. This is the case, for example, when a different medium is to be conveyed for which no filling program is available. The use of a different pump mechanism or different environmental conditions during conveying also enables the operator, in a very simple manner, to create new filling programs adapted to these parameters.

These self-created filling programs can advantageously be stored so that they can be retrieved at any time when needed.

The creation of a custom filling program is advantageously possible in such a way that, for parameterization, a programming mode of the filling control is activated, the drive is switched on and, after expiration of the desired filling time, the drive is switched off. The filling time and the rotational speed of the drive are detected and stored by the filling control.

The container pump is characterized in that it is equipped with the drive according to the disclosure. With such a container pump, a desired quantity of medium can therefore be pumped out very effectively and with high accuracy.

### BRIEF DESCRIPTION OF THE DRAWINGS

The invention is explained in greater detail below with reference to an embodiment illustrated in the drawings. The drawings show:

FIG. 1 a schematic representation of a container pump with a drive in an operating position.

FIG. 2 a schematic representation of the current-time profile of the drive during normal operation.

FIG. 3 a representation corresponding to FIG. 2 of the current-time profile during dry running of the drive.

FIG. 4 a perspective view of the drive.

FIG. 5 an axial section through the drive.

FIG. 6 the current-time profile of the drive during a pumping operation and upon occurrence of dry running.

FIG. 7 a flow diagram for detecting dry running of the drive.

FIG. 8 an enlarged view of an axial rotor of the container pump.

FIG. 9 a view corresponding to FIG. 8 of a semi-axial rotor of the container pump.

FIG. 10 a schematic representation of a filling operation with the container pump.

FIG. 11 a flow diagram for teaching a filling operation.

FIG. 12 a flow diagram showing the sequence of the filling operation.

### DETAILED DESCRIPTION

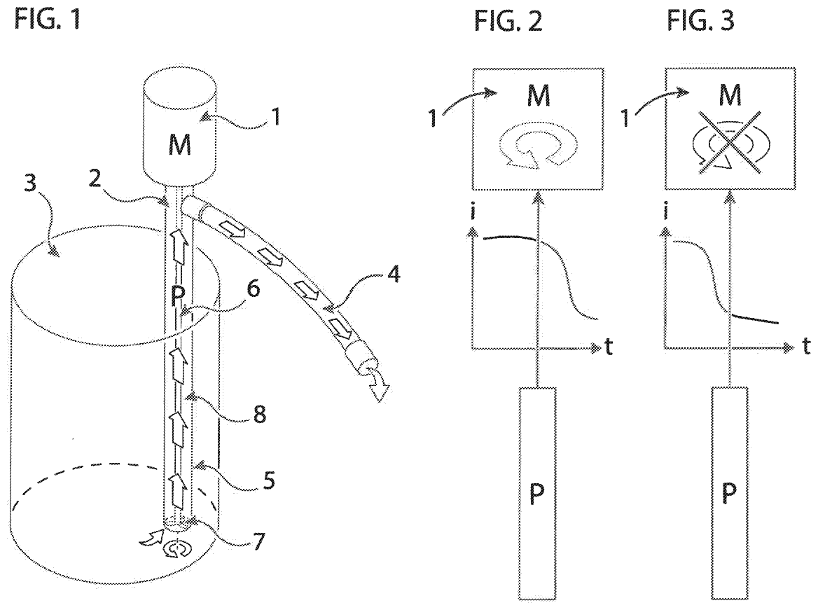

FIG. 1 shows, in a schematic representation, a pump system, which in the exemplary embodiment is a drum or container pump. The pump system has a drive 1 in the form of an electric motor, which is arranged at the upper end of a pump tube assembly 2. Within the pump tube assembly 2, a medium located in a supply container 3 is conveyed into a target container. The supply container 3 may be any container for the medium, e.g., a drum. The target container may likewise be any container for the medium, for example also a drum.

The pump tube assembly 2 has a pump tube 5, in which the medium is pumped from the lower end upward. Near the upper end, a hose line 4 is connected to the pump tube 5, via which the medium is conveyed from the supply container 3 to the target container. The flow path of the medium during the pumping process is indicated in FIG. 1 by flow arrows. The pump tube assembly may also be mounted vertically or horizontally in a dry-installed manner at a container connection.

A pump shaft 6 is located within the pump tube 5 and is drivingly connected to the drive 1, and at its lower end has a rotor 7, which is fixed in rotation with the pump shaft 6 and ensures that the medium is drawn into the pump tube 5.

The pump shaft 6 is rotatably mounted within the pump tube 5. An annular space 8 is formed between the pump shaft 6 and the pump tube 5, in which the medium is conveyed upward.

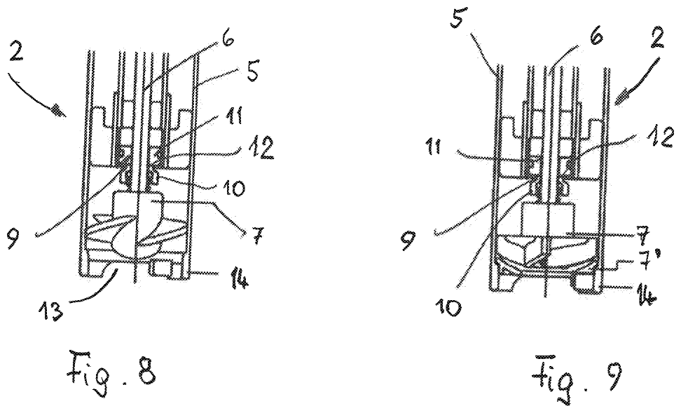

In the region above the rotor 7, end-face mechanical seals 9 (FIGS. 8 and 9) are provided for sealing the rotating pump shaft 6 relative to the pump tube 5. The mechanical seal 9 has a counter ring 10 fixed in rotation with the pump shaft 6, which bears with its end face, forming a sealing gap 12, against the end face of a stationary seal ring 11.

In the embodiment according to FIG. 8, the rotor 7 is an axial rotor, which is used for high flow rates at low delivery head. The rotor 7 is arranged at a small distance above an inlet opening 13 at the lower end of the pump tube 5. It has a foot portion 14 by means of which the pump tube 5 rests on the bottom of the supply container 3 and which includes the inlet opening 13 for the medium.

FIG. 9 shows an embodiment in which the rotor 7 is a semi-axial rotor, which is used when greater delivery heads with lower flow rates are desired. At high back pressure during the pumping process, the semi-axial rotor requires a lower load current compared to the axial rotor according to FIG. 8. The semi-axial rotor 7 cooperates with a pressure ring 7′ installed at the lower end of the pump tube 5.

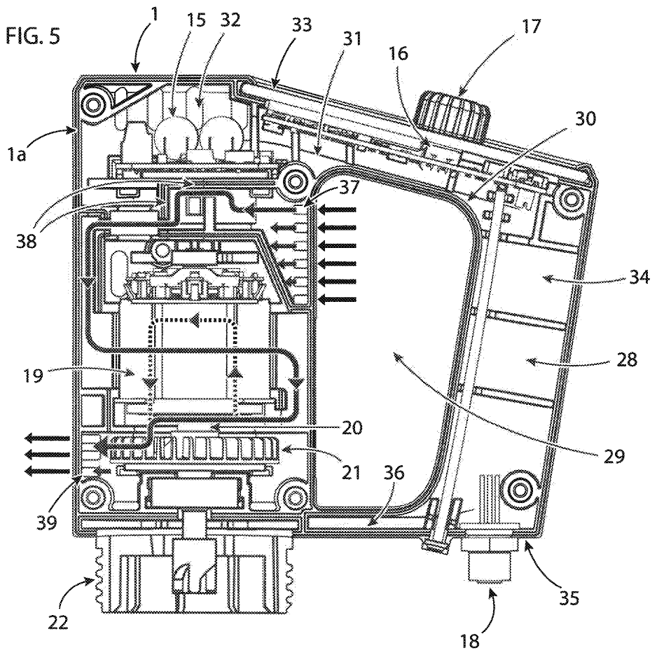

FIG. 5 shows the drive 1 in the form of the electric motor, which is configured as an EC motor. It has control electronics 15 that control the electric motor and supply it with energy.

In order to process operator input commands, the drive 1 is also provided with user interface electronics 16, which are advantageously configured to also visualize the motor status. For inputting operator commands, an user input element 17 is provided, which will be described in more detail below.

The drive 1 further has an interface 18 via which external peripherals can be connected and supplied with power. The peripherals may serve to control the motor by means of switching signals.

The interface 18 is advantageously a 24 V interface.

Below the control electronics 15, a drive unit 19 is provided, which comprises a stator and a rotor. The rotor has a rotor shaft 20 on which a fan wheel 21 is fixed in rotation, by means of which cooling air can be drawn into the interior of the motor or circulated within the motor.

The rotor shaft 20 is coupled with the pump shaft 6 to drive it rotationally. The pump shaft 6 and the rotor shaft 20 are provided with corresponding coupling elements by which the two shafts can be coupled in a rotationally fixed manner.

For fastening the pump tube assembly 2 to the drive 1 (FIG. 1), a screw coupling 22 (FIG. 5) is provided by way of example, by which the pump tube assembly 2 can be detachably connected to the drive housing 1a.

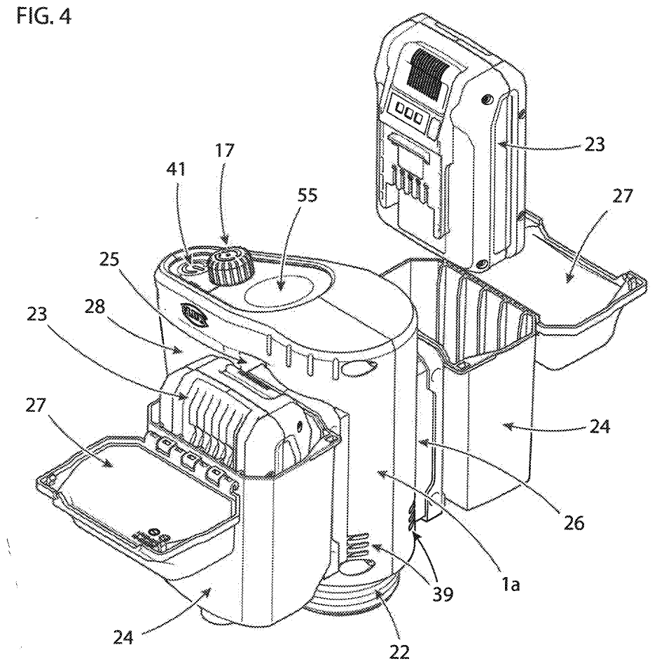

The electric motor is a battery-operated motor in the form of a brushless DC motor. It is supplied with energy, for example, by two batteries 23 (FIG. 4), which are advantageously identical so that they can be inserted interchangeably into their mounting positions.

For the batteries 23, two battery receptacles 24 are provided, arranged on opposite housing walls 25, 26 of the housing 1a. Each battery receptacle 24 is provided with a cover 27 by means of which the receptacle can be closed, thereby protecting the battery 23 located therein.

The housing 1a has a carrying handle 28 (FIG. 5), by which the drive 1 can be securely held. The carrying handle 28 has a grip opening 29, which is bounded at the top by an inclined leg 30. The user input element 17 is located on its upper side.

The leg 30 is provided with a receptacle 31 in which the user interface electronics 16 are accommodated. The receptacle 31 is open toward a receptacle 32 in which the control electronics 15 are accommodated and which is located at the upper side of the central region of the housing 1a.

At least the upper side 33 of the leg 30 is inclined downward, relative to the representation according to FIG. 5. As a result, the user input element 17 is easily accessible to the user, allowing reliable one-handed operation.

Preferably, the entire leg 30 is arranged in this inclined manner. Its end facing away from the central region of the housing 1a transitions into a handle portion 34 of the carrying handle 28. The handle portion 34 is advantageously configured as a hollow body so that it does not significantly increase the weight of the drive 1. An interface 18 is provided on the underside 35 of the handle portion 34 facing away from the leg 30. Connecting lines from the interface 18 to the user interface electronics 16 can be accommodated within the hollow handle portion.

The handle portion 34 extends from the leg 30 in a converging, downwardly inclined manner toward the central region of the housing 1a, such that the grip opening 29 narrows continuously downward.

At its lower end, the handle portion 34 is connected to the central region of the housing 1a by a cross member 36. The housing 1a with the carrying handle 28 is configured such that it widens continuously from the carrying handle (FIG. 4). The end of the housing facing away from the carrying handle is rounded.

The two battery receptacles 24 are arranged at the same height on the housing 1a and are dimensioned such that the grip opening 29 remains free, allowing comfortable gripping of the carrying handle 28.

It is advantageous if the housing 1a extends upward beyond the battery housings 24 and the covers 27. This has the advantage that the center of gravity of the drive 1 is located as low as possible, thereby increasing the stability of the drive 1 and providing a comfortable handling feel. The low center of gravity particularly contributes to the drive 1 having a reduced tendency to tip, especially when coupled to the pump tube assembly 2, such that the drive 1 can be connected to and removed from the pump tube assembly 2 more safely and conveniently.

The two battery receptacles 24 with the covers 27, together with the region of the housing 1a located therebetween, define a region that extends perpendicular to the carrying handle 28. As a result, it is achieved in a structurally simple manner that the drive 1 remains stable against tipping when set down without the pump tube assembly 2. Tipping of the drive 1 is thereby reliably prevented when the drive is placed on a flat surface. The batteries 23 in the battery receptacles 24 increase the stability as well as the user-friendliness of the drive 1.

Dividing the overall electronics into control electronics 15 and user interface electronics 16 provides significant advantages. The thermally critical control electronics 15, including its circuit board, can be arranged within a region of the drive 1 that can be effectively cooled during operation of the drive 1. In contrast, the user interface electronics 16, including its circuit board and the user input element 17, are less thermally critical and can therefore be arranged in a region that does not necessarily require cooling.

The housing 1a includes inlet openings 37 for ambient air (FIG. 5). The inlet openings 37 are preferably configured as slots and are provided on an outer side of the housing 1a opposite the handle portion 34.

The housing 1a is provided on its upper side with a display 55 on which indications necessary for the settings described below are displayed. Individual menu items can be selected and confirmed by means of the user input element 17, which is rotatable and depressible.

Within the housing 1a, thermally conductive wall sections 38 are preferably provided, which serve as guides for the cooling air. The wall sections 38 shield the control electronics 15 and delimit a compartment in the direction of the fan wheel 21. The wall sections 38 thus form an enclosure for the sensitive control electronics 15. This ensures that potentially aggressive cooling air does not reach the control electronics 15 or its components.

Cooling air flows through the housing 1a (indicated by flow arrows and solid lines) and exits the housing 1a through outlet openings 39 to the outside. The outlet openings 39 are preferably arranged in a region between the two battery receptacles 24 on a side of the housing facing away from the carrying handle 28 (FIG. 4), and, in a vertical configuration, are preferably located below the inlet openings 37. In this way, potentially aggressive vapors from the pumped medium are advantageously directed away. The cooling air entering through the inlet openings 37 is thereby protected from aggressive medium vapors.

To further increase safety against potentially aggressive ambient air, the housing 1a may also be configured without the inlet openings 37 and the outlet openings 39. In this case, no aggressive cooling air can enter the housing 1a. Instead, internal motor cooling is achieved by means of the fan wheel 21, which circulates the air present within the housing 1a. The flow path is indicated in FIG. 5 by a dashed line. In such an embodiment, the performance of the drive 1 is reduced in favor of increased safety.

In this way, it is reliably ensured that no aggressive cooling air from the outside enters the housing 1a.

Via the interface 18, external sensors such as flow meters, level sensors, and other sensors can be connected to the drive 1. As a result, no additional power supply is required, for example from a control cabinet. The drive 1 can therefore be handled in a mobile and convenient manner, since no cable connection to a control cabinet or the like is required. The pump system is thus configured to be self-contained, i.e., it does not require an external power supply for the pumping operation.

The drive 1 is a battery-powered motor configured such that damage to the drive 1, and thus to the entire pump system, is reliably avoided without the need for additional sensors. The drive 1 includes a dry run detection function configured to determine whether a dry run condition is present, as described in greater detail below. Upon detection of a dry run condition, the drive 1 is automatically switched off in order to prevent, for example, overheating and damage to mechanical seals used in the pump system.

In such a mechanical seal, the sealing gap 12 between the counter ring 10 and the seal ring 11 is critical. The sealing gap 12 must be lubricated by the pumped medium to prevent a dry run condition of the mechanical seal. If insufficient medium is present and the sealing gap 12 is therefore not supplied, or not sufficiently supplied, with the medium as a lubricant, a dry run condition occurs, in which the two sealing rings 10, 11 overheat and fail.

The same applies to other types of seals, such as lip seals, as well as to other failure conditions, such as shaft breakage.

In order to reliably and safely prevent such a dry run condition, the active power or the load current of the battery-powered motor is monitored during operation of the pump system. During the pumping operation, the required motor current is measured over a defined period of time, and an average value is determined from these data and used as a reference value. Tolerances are assigned to the reference value so that minor deviations from the reference value are not interpreted as a dry run condition.

The monitoring of the motor current is continued, with each newly measured current value being compared to the reference value. If a deviation of the measured current value from the reference value falls below a predefined threshold for a defined period of time, this is interpreted as a dry run condition, and the drive 1 is switched off.

If the measured current value is above the threshold, that measured current value is used for determining the reference value to form a new reference value. The new value replaces the oldest value of the existing set of measured values.

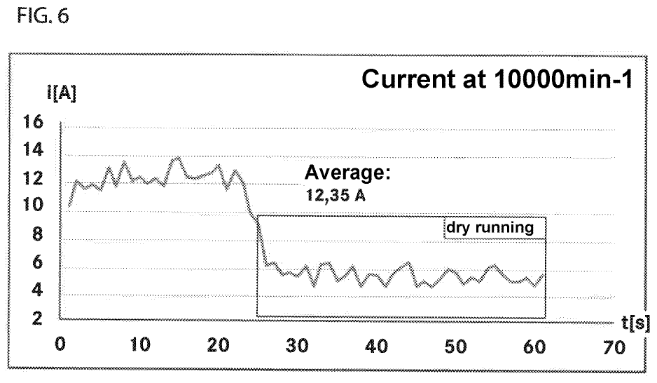

FIG. 6 shows a typical current-time curve of a pump system. In the illustrated example, the pump shaft 6 rotates at a rotational speed of 10,000 rpm. By way of example, the average value is indicated as a reference value of 12.35 A. The curve shows the respective measured current values during the pumping operation. These measured current values lie within a predefined tolerance range, such that the controller assumes that the pump system is operating properly and that no dry run condition is present.

FIG. 6 further illustrates, by way of example, a situation in which the current values drop significantly and fall below a predefined threshold relative to the average value. If this undershoot of the threshold persists for a predefined period of time, it is interpreted as a dry run condition. In the example, a period from about 25 seconds to about 60 seconds is indicated. During this period, the measured current values lie well below the defined threshold. Detection typically occurs within one to a few seconds.

Since only the motor current is monitored to detect a dry run condition, no additional liquid sensors are required. This reduces both cost and installation effort.

During dry run detection, the rotational speed of the pump shaft 6, and thus also of the drive shaft of the drive 1, is maintained at least approximately constant. Because current measurement depends on rotational speed, this ensures high quality and accuracy of the current detection.

With reference to FIGS. 8 and 9, it is illustrated how the configuration of the pump tube assembly 2 influences the current measurement.

If the hose line 4 is provided at its free end with a dispensing nozzle, then, when the dispensing nozzle is in a closed state and a semi-axial rotor 7 according to FIG. 9 is used, the load current decreases. In contrast, when an axial rotor 7 according to FIG. 8 is used, the motor current increases when the dispensing nozzle is closed.

The load current changes that occur due to opening and closing of the dispensing nozzle are distinguished from load current changes caused by a dry run condition. This is achieved by evaluating whether the undershoot of the predefined threshold persists over a defined period of time. When the dispensing nozzle is closed, the load current changes occur only for a short duration, such that it can be reliably distinguished whether the load current change is caused by closure of the dispensing nozzle or by a dry run condition.

FIG. 2 shows, in a simplified representation, a current-time curve during a normal pumping operation, in which the drive 1 rotates the pump shaft 6. The motor current is high at the beginning of the pumping operation, when the supply container 3 is still full, and gradually decreases as the pumping operation continues, since the quantity of the pumped medium in the supply container 3 correspondingly decreases.

FIG. 3 shows, by way of example, a case in which the motor current drops significantly after a short time and then changes only slightly over a longer period. As explained with reference to FIG. 6, this is an indication that a dry run condition is present. Accordingly, the drive 1 is switched off to prevent damage to the mechanical seal 9.

The current measurement is performed by means of a control unit that not only detects the motor current during the pumping operation but also sets the relevant parameters when the motor is switched on.

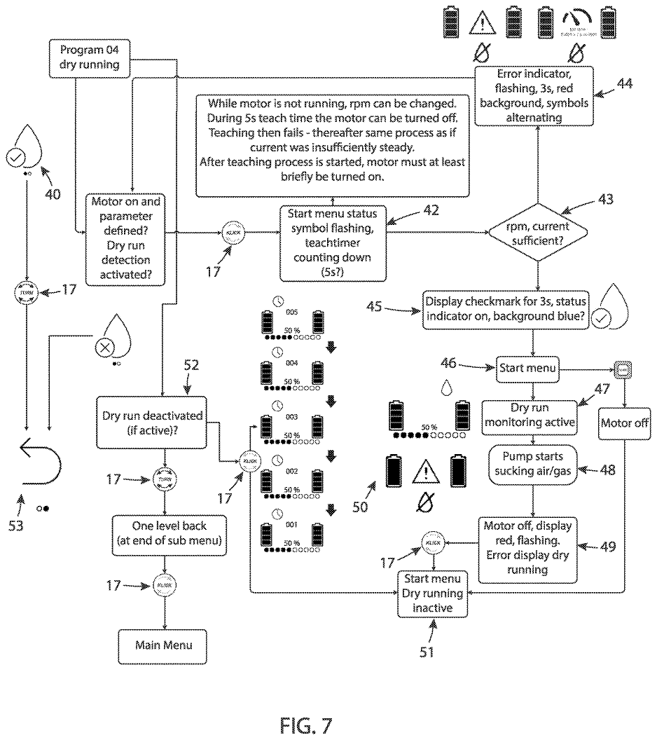

With reference to FIG. 7, a sequence of a pumping operation with dry run detection is described.

Initially, at time point 40, it is queried, by actuating a switch 41 (FIG. 4), whether the dry run detection is to be activated. A start menu 42 is displayed, and at the same time a teach-in time begins to run, which in the illustrated example lasts 5 seconds. During this teach-in time, the drive 1 must be switched on at least briefly. As long as the drive 1 is not yet running, the rotational speed of the rotor shaft 20, and thus of the pump shaft 6, can be adjusted.

In step 43, the controller checks whether the rotational speed and the motor current are sufficiently stable for the pumping operation. If this is not the case, an error indication is generated in step 44 indicating that the rotational speed and the motor current are not sufficient for the pumping operation.

If, in step 43, it is determined that the rotational speed and the motor current are sufficient, a corresponding confirmation 45 is provided and a start menu 46 is displayed. This indicates that the dry run monitoring (step 47) is active.

At time point 48, it is assumed that the pump system begins to draw in air or gas. As a result, an insufficient quantity of pumped medium is delivered, such that the mechanical seal 9 is no longer adequately lubricated and a dry run condition may occur. In step 49, the controller then switches off the drive 1 and outputs an error signal 50. By actuating the user input element 17, the start menu display is activated and an indication is displayed that the dry run detection is inactive (step 51). This indication may, for example, be provided by displaying a symbol or by the absence of a symbol that would otherwise be displayed.

After step 40, the user input element 17 may be rotated such that, in step 52, it is indicated whether the dry run detection can be deactivated, provided that it had previously been activated. If the dry run detection is to be deactivated, the user input element 17 is actuated again, such that, in step 51, it is indicated that the dry run detection is deactivated.

By rotating the user input element 17, it is possible to return the display structure to a higher-level display (menu display 53). This higher-level display can then be confirmed by actuating the user input element 17.

When the drive 1 is switched on, parameters necessary for the pumping operation and for dry run detection are established. As a result, the pumping operation can subsequently be carried out reliably.

The described method for dry run detection using the battery-powered drive 1 without additional sensors provides a cost-effective and rapid solution for preventing damage to pumps. In this approach, monitoring of the active power or the load current of the drive 1 is used to interpret the operating state of the pump. Upon detection of a dry run condition, the drive 1 is automatically switched off to prevent overheating and damage to the mechanical seal 9.

The pump also enables highly accurate, time-controlled filling of a pumped medium. This so-called time-controlled filling function is based on the selection of predefined programs in which the filling time and the rotational speed of the drive 1 are specified. The operator may create and store new filling programs or retrieve and execute stored programs.

This filling function is particularly suitable for mobile, especially battery-powered, container pumps and enables simple and accurate control of the filling operation. The filling function provides a user-friendly approach for regulating the filled quantity in a time-controlled manner at a fixed rotational speed of the drive 1. This advantageous capability is particularly useful in applications where consistency and repeatability are critical.

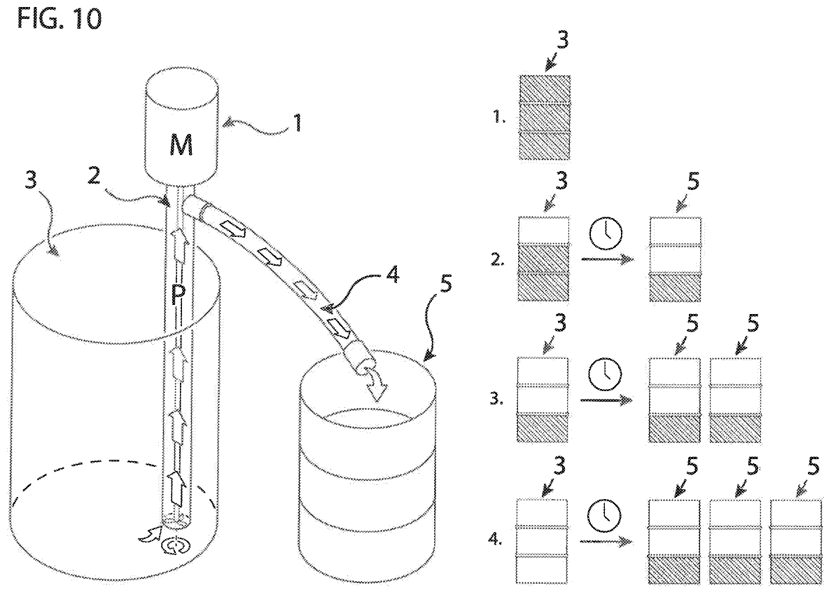

FIG. 10 illustrates, by way of example, how a constant filling quantity can be repeatedly removed from the supply container 3 and delivered to a target container 5 in a time-controlled manner. At time point 1, the supply container 3 is completely filled. At time point 2, for example, one third of the pumped medium is transferred from the supply container 3 into the target container 5.

In step 3, it is illustrated, by way of example, how a further quantity of the pumped medium is transferred from the supply container 3 into a second target container 5. In the example, one third of the original quantity of pumped medium in the supply container 3 is again transferred into the second target container 5.

In step 4, it is illustrated, by way of example, that the remaining quantity of pumped medium in the supply container 3 is transferred into a third target container 5.

This example shows that the pumped medium is distributed in equal portions, each corresponding to one third, to three different target containers 5.

The indicated delivered quantities are, of course, merely examples and are not limiting.

For the filling operation, the operator selects a predefined program that specifies the filling time and the rotational speed of the drive 1. Based on the filling time and the rotational speed, the delivered quantity of pumped medium can be readily determined. In this way, a preferably constant filling rate and simple control of the filling quantity are achieved.

Instead of the rotational speed of the drive 1, the current consumption or the torque of the drive may alternatively be used as a parameter in conjunction with the filling time.

The drive 1 is provided with a program controller 15, 16 by means of which controlled filling can be carried out easily and reliably. The program controller includes predefined programs stored in a memory and selectable by the operator.

Before the drive 1 is switched on, the operator can actuate the user input element 17 to call up a program selection and select a suitable filling program from the stored programs. The rotational speed of the drive 1 is automatically set to the rotational speed associated with the selected program to ensure uniform filling.

While the drive 1 is running, the filling time is counted down. Advantageously, the operator can monitor the time on a display. The program controller may further include an integrated counter that indicates the number of filling operations performed, thereby informing the operator how many times the program has been executed.

Once the stored filling time has elapsed, the drive 1 is automatically switched off.

The program controller is further advantageously configured such that the operator can create a program.

To create a new filling program, the operator keeps the drive 1 switched on until the desired filling quantity is reached. The drive 1 is then switched off. The program controller stores the set rotational speed of the drive 1 and the elapsed time.

The operator can store the newly created program and assign a storage location to the program, such that the newly created program can be retrieved at a later time. The user-created filling program can be added to the list of predefined programs, such that the operator only needs to select the corresponding program from a list. It is also possible to store the user-created filling programs in an available storage location or to overwrite an already occupied storage location.

If the operator is not satisfied with the filling result of the newly created filling program, the operator can repeat the described filling operation and store it again. In doing so, the previously stored filling program is advantageously overwritten.

The operator can also select a previously stored filling program from a list of stored programs. This can be done easily using the user input element 17. By rotating the user input element 17, the corresponding program is selected, with the program list being displayed, for example, on a display. Once the desired filling program has been selected by rotation of the user input element 17, it is activated by pressing the user input element 17. When the drive 1 is subsequently switched on, filling is performed in accordance with the selected filling program.

To ensure repeatability of each filling operation, it should be noted that each filling program is configured for a specific pumped medium. Accordingly, a filling program designed for a first pumped medium A cannot be used for a filling operation involving a different pumped medium B. In such cases, it is necessary to use a different filling program adapted to the pumped medium B or, as described above, to create a suitable filling program.

Repeatability of the filling operation likewise requires that the same pump system be used. If different pump systems are employed, constant filling quantities cannot be achieved using the same filling program. In such cases as well, it is necessary to create a separate filling program for each respective pump system.

Environmental conditions during pumping also play a role, such as temperature, humidity, fill level, and the like. Accordingly, the respective filling programs are created taking these environmental conditions into account. If different environmental conditions prevail, the stored filling programs may not be usable or may be usable only to a limited extent. In such cases, it is likewise recommended to create and store a new filling program adapted to the different environmental conditions.

The time-controlled filling function enables rapid processing of filling tasks. Due to the simple operation, the user can easily carry out the respective filling operation quickly. No additional measuring or control devices, such as scales, are required for the described filling operations. This simplifies handling, particularly in mobile, cordless applications. Because filling programs can be stored, retrieved, and easily created, the efficiency of the filling process is increased. In particular, the simple creation of user-defined filling programs makes it possible to create and store different filling programs for different filling requirements.

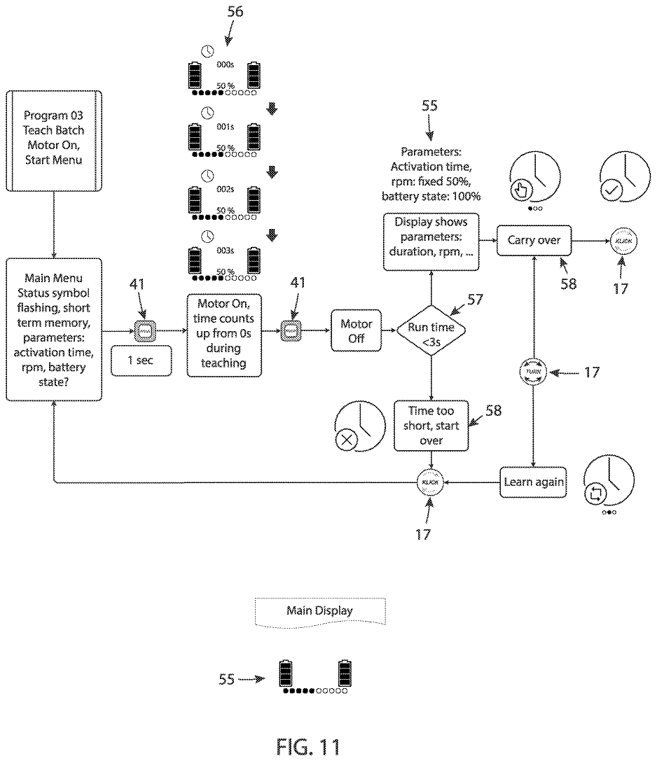

FIG. 11 shows a flow diagram for a teach-in process for a new filling operation. The display 55 is activated, for example by actuating the user input element 17. On the start screen, parameters such as rotational speed and battery charge level are displayed. The switch 41 is then actuated, thereby starting the filling operation. At the same time, a teach-in process (56) is initiated, during which the time required for the filling operation is recorded. Once the desired filling time has been reached, the switch 41 is actuated again, thereby switching off the drive 1.

The programming is configured such that a pumping time of, for example, at least three seconds must be present. Accordingly, in step 57 it is checked whether this minimum filling time has been reached. If this is not the case, an indication 58 is displayed on the display 55 that the filling time was too short. The teach-in process 56 can then be repeated by actuating the user input element 17.

If, in step 57, it is determined that the filling time is greater than, for example, 3 seconds, a corresponding confirmation message is displayed on the display 55, in which the activation duration and the rotational speed of the drive 1 are also indicated. In step 58, the operator can decide whether the displayed parameters are acceptable. If the parameters (activation duration and rotational speed) are acceptable, the user input element 17 is actuated, whereby the set parameters are temporarily stored as a new filling program.

If the parameter values displayed in step 58 are not yet satisfactory to the operator, the operator can rotate the user input element 17 to initiate a new teach-in process 56.

The described sequence for learning a new filling program is very simple for the operator, particularly since the necessary parameters are displayed on the display 55 and can be confirmed or rejected by the operator.

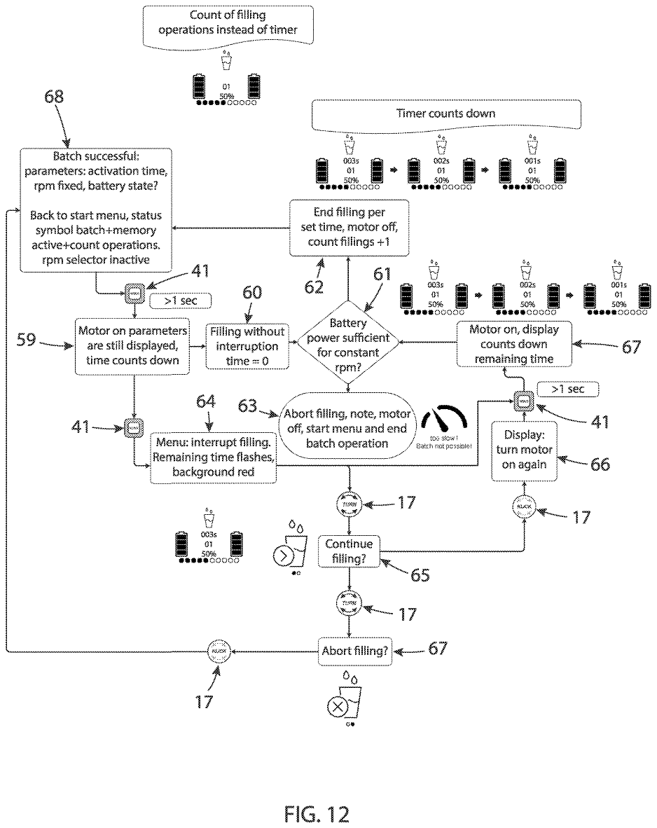

With reference to FIG. 12, the sequence of the filling operation is illustrated by way of example in a flow diagram.

Initially, a main menu is displayed on the display 55. The available filling programs are shown and can be selected and activated using the user input element 17. The filling time of the selected filling program is then displayed on the display 55. In addition, the display 55 may indicate whether the battery charge level is sufficient to carry out the filling operation.

Once the desired filling program has been activated, the drive 1 is switched on by actuating the switch 41. The parameters continue to be displayed on the display 55, while the pumping time counts down (step 59).

Once the time has counted down to zero (step 60), the drive 1 is switched off. Advantageously, a counter is simultaneously incremented (e.g., set to 1 for the first cycle) to record the number of filling operations. For subsequent filling operations, the counter is incremented accordingly to 2, 3, and so on.

In step 61, it is checked whether the battery power is sufficient to maintain a constant rotational speed of the drive 1. If this is the case, the drive 1 is automatically switched off in step 62 when the filling quantity according to the selected filling program has been reached. If this is not the case, the filling operation is aborted in step 63 and a corresponding indication is displayed on the display 55. In this case as well, the drive 1 is switched off and the display is reset to an initial state or turned off.

After step 59, the switch 41 may be actuated before expiration of the filling time. In that case, an interruption of the filling operation is indicated on the display 55 and a corresponding signal is output (step 64). Advantageously, the remaining time is displayed on the display 55 in step 64. The user input element 17 may then be rotated to resume the filling operation (step 65). When this menu item is selected in step 65, the user input element 17 can be actuated, whereby an indication is displayed on the display 55 in step 66 that the drive 1 can be switched on again. This can be carried out by the operator by actuating the switch 41. The display 55 then indicates in step 67 that the drive 1 is switched on. At the same time, the remaining time is counted down on the display 55 until the time reaches zero. The drive 1 is then switched off in accordance with step 62.

Alternatively, in step 65, the user input element 17 may be rotated again, whereby an indication appears on the display 55 in step 67 as to whether the filling operation is to be aborted. This can be confirmed by actuating the user input element 17. The display 55 then returns to its initial state 68.

The described filling function represents a significant improvement in filling technology. It combines precision, efficiency, and flexibility to meet the requirements of modern production processes. The ability to easily create, store, and retrieve filling programs significantly accelerates the processing of filling tasks. The simple operation and the absence of additional measuring or control devices make the pump system particularly user-friendly and cost-effective, especially for battery-powered applications. Moreover, adherence to the described conditions ensures high repeatability and consistency of the filling operations. Overall, the time-controlled filling function provides a reliable and versatile solution for a wide range of filling applications, optimizing production processes and increasing productivity.

What is claimed is:

1. A drive for a pump shaft of a pump tube assembly of a container pump,
wherein the drive comprises a controller including a filling control configured to control at least one filling program,
wherein, by execution of the at least one filling program, a quantity of a pumped medium is pumped in a time-controlled manner.

2. The drive of claim 1,
wherein the time control is based on a filling time and a rotational speed of the drive.

3. The drive of claim 1,
wherein the at least one filling program comprises a plurality of selectable filling programs.

4. The drive of claim 1,
wherein the at least one filling program is stored in a memory.

5. The drive of claim 4,
wherein the memory is arranged within the drive.

6. The drive of claim 1,
wherein the drive is configured to automatically switch off upon expiration of a predefined filling time.

7. The drive of claim 1,
wherein the drive comprises an electric motor.

8. The drive of claim 1,
wherein the filling control is configurable to generate additional filling programs.

9. The drive of claim 8,
wherein the additional filling programs are storable in a memory.

10. The drive of claim 1,
wherein the filling control is configured to execute a programming mode in which:
the drive is switched on,
the drive is switched off after a filling time, and
the filling time and a rotational speed of the drive are detected and stored.

11. A container pump, comprising:
a pump tube assembly; and
the drive according to claim 1 configured to drive the pump tube assembly.
